(19) United States
(12) Patent Application Publication
(10) Pub. No.: US 2017/0280748 A1
(43) Pub. Date: Oct. 5, 2017

(54) Hydrogen-Containing Water Product for Beverage

(71) Applicant: SHEFCO CO., LTD., Tokyo (JP)

(72) Inventor: Junichi IGARASHI, Tochigi (JP)

(21) Appl. No.: 15/513,554

(22) PCT Filed: Sep. 25, 2015
(86) PCT No.: PCT/JP2015/077114

§ 371 Date: Mar. 22, 2017

(30) Foreign Application Priority Data
Sep. 25, 2014 (JP) 2014-195585

(51) Int. Cl. A23L 2/52; B65D 85/72; B65D 75/58; B65B 3/10; C02F 1/02; B65B 63/08; B65B 61/20; B65D 75/54; C02F 1/68; A23L 3/10; B65B 7/02

(52) U.S. Cl. CPC A23L 2/52; A23L 3/10; B65D 85/72; B65D 75/5883; B65B 3/10; B65B 7/02; B65B 63/08; B65B 61/205; B65D 75/54; C02F 1/68; C02F 1/02; A23V 2002/00

(57) ABSTRACT

To provide a hydrogen-containing water product which maintains the oxidation-reduction potential at a low value even when a certain period of time elapses after manufacture.

A hydrogen-containing water product for beverage including: a packaging container with a straw having a sealing cap attached to an opening; hydrogen-containing water filled in the container under pressure; and a gas atmosphere that is generated in a space above the hydrogen-containing water in the container by a heat treatment conducted after the filling under pressure and is present even when at least 90 days elapse after generation, wherein the hydrogen-containing water has an oxidation-reduction potential of {[−59×(pH value of hydrogen-containing water in hydrogen-containing water product for beverage after elapse of 90 days)]−170} mV or less when being stored at normal temperature for at least 90 days after manufacture.

### TECHNICAL FIELD

The present invention relates to a hydrogen-containing water product for beverage and a method of manufacturing the same.

### BACKGROUND ART

In recent years, hydrogen-containing water (also referred to simply as hydrogen water) in which hydrogen gas is dissolved in water has attracted attention since it exhibits high reducibility and thus it is regarded to have an effect of suppressing oxidation of metals and putrefaction of foods and it is expected to improve various health problems in the case of being diverted for drinking.

As a method of manufacturing the above-described hydrogen-dissolved water for drinking, for example, there is a method in which hydrogen gas from a gas cylinder is dissolved in raw water or hydrogen gas generated by electrolysis of water is dissolved in raw water (for example, Patent Literature 1). However, the dissolved hydrogen concentration is significantly lower than the saturated hydrogen concentration by merely supplying hydrogen gas into raw water since nitrogen gas, oxygen gas, and the like which are dissolved in the raw water interfere the dissolution of hydrogen gas at room temperature and atmospheric pressure.

In addition, for example, a method has been proposed in which hydrogen gas is efficiently dissolved by filling hydrogen gas in a pressure container from which the air has been removed and sprinkling raw water in the pressure container in a shower shape while maintaining the pressure of hydrogen gas in the pressure container at from 2 atm to 10 atm to bring the raw water into contact with the hydrogen gas (Patent Literature 2).

Alternatively, a method has been proposed in which ultrafine bubbles (so-called “nanobubbles” or “microbubbles”) are generated by jetting hydrogen gas into water at a high pressure and these are dissolved in water (Patent Literature 3).

### CITATION LIST

### Patent Literature

Patent Literature 1: JP 2002-254078 A

Patent Literature 2: JP 3606466 B1

Patent Literature 3: JP 2011-230055 A

### SUMMARY OF INVENTION

### Technical Problem

As described above, various manufacturing methods of hydrogen-containing water have been proposed in order to realize a higher dissolved hydrogen concentration. Moreover, there has been proposed a hydrogen-containing water product for beverage in which the hydrogen-containing water obtained by the methods is mainly filled in a packaging container with a straw to which a cap is attached. However, even if hydrogen-containing water realizing a high dissolved hydrogen concentration can be manufactured, a problem arises that the air dissolves in the hydrogen-containing water and the dissolved hydrogen concentration in the hydrogen-containing water decreases when the hydrogen-containing water is brought into contact with the air during filling and sealing of the hydrogen-containing water in a storage container such as a packaging container with a straw or in the storage container after sealing.

### Solution to Problem

As a result of intensive investigations to solve the above-mentioned problems, the present inventors have found out that it is possible to fill and seal hydrogen-containing water in a container while maintaining a higher dissolved hydrogen concentration as compared to an existing technology by filling hydrogen-containing water having an increased dissolved hydrogen concentration in a packaging container with a straw under pressure. As a result, the amount of hydrogen gas generated in the container after the heat treatment is greater than ever. When a hydrogen-containing water product having a gas atmosphere in the container even when being stored for a long period of time after manufacture is manufactured by this, it is possible to maintain the oxidation-reduction potential of the hydrogen-containing water at a low value and the dissolved hydrogen concentration at a high value even when a certain period of time elapses after manufacture by the presence of this gas atmosphere. The present invention has been thus completed.

That is, the present invention relates to a hydrogen-containing water product for beverage including:

a packaging container with a straw having a sealing cap attached to an opening;

hydrogen-containing water filled in the container under pressure; and

a gas atmosphere that is generated in a space above the hydrogen-containing water in the container by a heat treatment conducted after the filling under pressure and is present even when at least 90 days elapse after generation, wherein

the hydrogen-containing water has an oxidation-reduction potential of {[−59×(pH value of hydrogen-containing water in hydrogen-containing water product for beverage after elapse of 90 days)]−170} mV or less when being stored at normal temperature for at least 90 days after manufacture.

In the present invention, it is preferable that the gas atmosphere is an atmosphere having a partial pressure of hydrogen gas of 90% or more with respect to the entire atmosphere pressure.

Additionally, it is preferable that the hydrogen-containing water has a dissolved hydrogen concentration at the time of filling to be equal to or higher than a saturated hydrogen concentration in water at a temperature of the hydrogen-containing water at the time of filling at atmospheric pressure.

Furthermore, in the hydrogen-containing water product for beverage of the present invention, it is particularly preferable that a product volume of the container is from 150 mL to 550 mL.

Particularly in the hydrogen-containing water product for beverage of the present invention, it is preferable that the hydrogen-containing water has an oxidation-reduction potential of {[−59×(pH value of hydrogen-containing water in hydrogen-containing water product for beverage after elapse of 90 days)]−180} mV or less when being stored at normal temperature for at least 90 days after manufacture. More preferably, it is desirable that the oxidation-reduction potential is {[−59×(pH value of hydrogen-containing water in hydrogen-containing water product for beverage after elapse of 90 days)]−190} mV or less.

Additionally, the present invention also relate to a method of manufacturing a hydrogen-containing water product for beverage, in detail, the method including:

a filling step of filling hydrogen-containing water in a packaging container with a straw having a sealing cap attached to an opening under pressure;

a sealing step of sealing the opening of the packaging container with a straw in which the hydrogen-containing water was filled with the sealing cap; and

a heat treatment step of subjecting the filled and sealed product to a heat treatment, wherein

the hydrogen-containing water product for beverage has a gas atmosphere that is generated in a space above the hydrogen-containing water in the container by a heat treatment conducted after the filling under pressure and is present even when at least 90 days elapse after generation, and

the hydrogen-containing water has an oxidation-reduction potential of {[−59×(pH value of hydrogen-containing water in hydrogen-containing water product for beverage after elapse of 90 days)]−170} mV or less when being stored at normal temperature for at least 90 days after manufacture.

Especially, it is preferable that the hydrogen-containing water is filled in the packaging container with a straw at a load pressure of from 0.1 MPa to 0.5 MPa in the filling step.

Furthermore, it is preferable that the heat treatment is conducted at a temperature of from 85° C. to 90° C. under a heating condition of from 20 minutes to 1 hour in the heat treatment step.

### Advantageous Effects of Invention

In the hydrogen-containing water product for beverage of the present invention, the hydrogen-containing water in the container has an oxidation-reduction potential of {[−59×(pH value of hydrogen-containing water in hydrogen-containing water product for beverage after elapse of 90 days)]−170} mV or less when being stored at normal temperature for at least 90 days after manufacture. It is thus possible to provide hydrogen-containing water with stable quality.

Furthermore, in the method of manufacturing a hydrogen-containing water product for beverage of the present invention, the hydrogen-containing water in the container has an oxidation-reduction potential of {[−59×(pH value of hydrogen-containing water in hydrogen-containing water product for beverage after elapse of 90 days)]−170} mV or less when being stored at normal temperature for at least 90 days after manufacture. It is thus possible to provide hydrogen-containing water with stable quality.

### BRIEF DESCRIPTION OF DRAWINGS

FIG. 1 is a perspective view illustrating an embodiment of the hydrogen-containing water product for beverage of the present invention.

FIGS. 2(a) and 2(b) are enlarged views of the vicinity A of the opening of the straw of the hydrogen-containing water product for beverage illustrated in FIG. 1.

FIG. 3 is a graph illustrating a change in dissolved hydrogen concentration dH (ppm) in the hydrogen-containing water product for beverage manufactured in Example 5 with respect to the days elapsed after manufacture.

FIG. 4 is a graph illustrating a change in oxidation-reduction potential ORP (mV) of the hydrogen-containing water product for beverage manufactured in Example 5 with respect to the days elapsed after manufacture.

### DESCRIPTION OF EMBODIMENTS

As described above, various manufacturing methods of hydrogen-containing water have been so far investigated, and it has been possible to realize a high dissolved hydrogen concentration. However, a problem has arisen that the hydrogen-containing water is brought into contact with the air during filling, sealing, and storage of the hydrogen-containing water and the dissolved hydrogen concentration in the hydrogen-containing water decreases.

In addition, in the case of a hydrogen-containing water product for beverage, the hydrogen-containing water is required to be subjected to a heat treatment after being filled and sealed in the storage container for sterilization from the viewpoint of food hygiene. In association with an increase in temperature of the hydrogen-containing water in the container due to this heat treatment, the saturated hydrogen concentration decreases and hydrogen dissolved in the hydrogen-containing water is not maintained in the dissolved state but vaporizes, and usually it accumulates in the vicinity of the cap to be the upper part of the container and the suction portion (spout) of the upper part of the straw. The vaporized hydrogen (gas) does not immediately dissolve in the hydrogen-containing water again even though the product is cooled after the heat treatment, and thus the hydrogen-containing water and the hydrogen gas are temporarily present together in the container. In other words, the dissolved hydrogen concentration in the hydrogen-containing water in the container temporarily greatly drops. Thereafter, the hydrogen gas in the container generated after the heat treatment dissolves in the hydrogen-containing water again with the elapse of time (usually about 1 weeks to 2 weeks). The dissolved hydrogen concentration approaches the dissolved hydrogen concentration at the time of filling. However, in the case of using a packaging container with a straw as the storage container, it is difficult to perfectly maintain the airtightness of the opening (namely, the suction portion: spout) and the cap of the packaging container with a straw. The space in the container slightly communicates with the outer space. Hence, it is inevitable that the air from the outside of the container gradually flows into the container with the elapse of time even though it is a significantly small amount. Moreover, a decrease in dissolved hydrogen concentration caused by the contact of the hydrogen-containing water with the air is inevitable.

As described above, the conventional hydrogen-containing water product in which hydrogen-containing water is filled and sealed in a packaging container with a straw has a problem that the dissolved hydrogen concentration in the hydrogen-containing water decreases over time after manufacture. Hence, a hydrogen-containing water product is demanded which maintains the dissolved hydrogen concentration as high as possible even in a case in which a long period of time (for example, a period of about 3 months to 6 months or longer) elapses after manufacture.

The present invention has been made to solve such a problem. In the present invention, a decrease in dissolved hydrogen concentration in hydrogen-containing water is suppressed as much as possible by filling the hydrogen-containing water in a container under pressure.

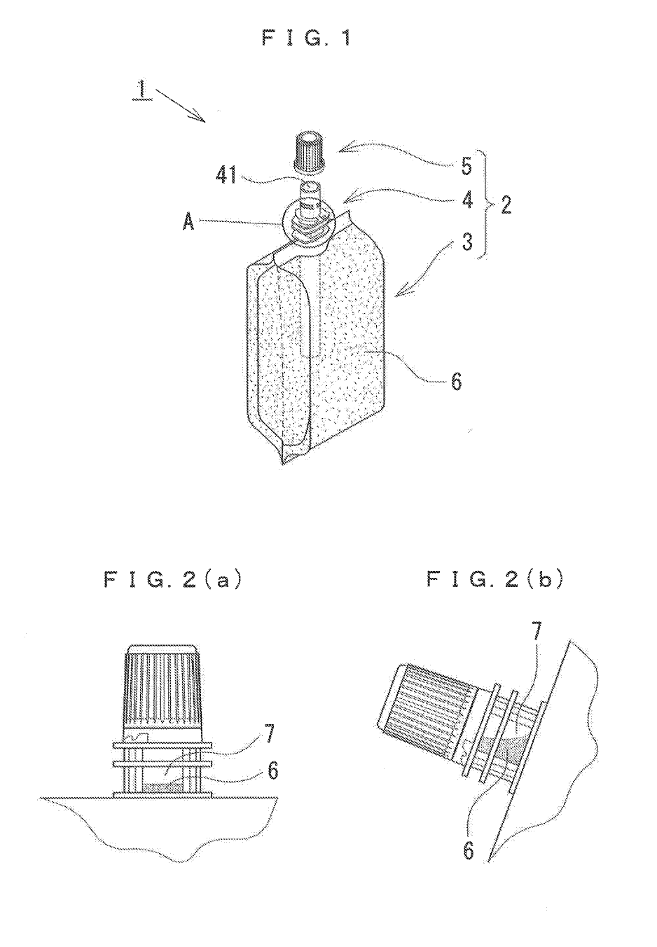

The hydrogen-containing water product for beverage of the present invention is constituted by a packaging container with a straw having a sealing cap attached to the opening, hydrogen-containing water filled in the container under pressure, and a gas atmosphere that is generated in the space above the hydrogen-containing water in the container by a heat treatment conducted after the filling under pressure. An example of an embodiment of the hydrogen-containing water product for beverage of the present invention is illustrated in FIG. 1. The hydrogen-containing water product for beverage 1 illustrated in FIG. 1 is in a form in which hydrogen-containing water 6 is filled in a packaging container with a straw 2 constituted by a container body 3, a straw 4, and a sealing cap 5 and an opening 41 of the straw 4 is then sealed with a cap 5.

The gas atmosphere is present even after the elapse of at least 90 days and preferably after the elapse of 180 days. The gas atmosphere is particularly preferably in a form in which the partial pressure of hydrogen gas is 90% or more with respect to the entire atmosphere pressure. Incidentally, a hydrogen gas atmosphere is generated by the heat sterilization treatment after filling in the conventional hydrogen-containing water product for beverage in which hydrogen gas is filled at atmospheric pressure as well. However, the hydrogen gas atmosphere substantially disappears by re-dissolution of the hydrogen gas at the stage of cooling the product to normal temperature after the heat sterilization. On the contrary, in the hydrogen-containing water product for beverage of the present invention, the hydrogen gas atmosphere is continuously present even at the stage of cooling the product to normal temperature after the heat treatment. In other words, in the hydrogen-containing water product for beverage of the present invention, the hydrogen-containing water and the gas atmosphere are continuously present together in the container during the storage period after manufacture. Hence, the sound (for example, imitation sound such as splish-splash and click-click) that the hydrogen-containing water hits the inner wall of the container is generated when the product is lightly shaken up and down. The presence of the gas atmosphere is confirmed by this sound.

In addition, the presence or absence of the gas atmosphere can be confirmed from the outside of the straw exposed between the container body and the sealing cap when the straw of the container with a straw to be described later is transparent or translucent. An enlarged view of the vicinity A of the opening 41 of the straw 4 of the hydrogen-containing water product for beverage 1 illustrated in FIG. 1 is illustrated in FIGS. 2(a) and 2(b). In other words, in a case in which a gas atmosphere is present in the hydrogen-containing water product for beverage, the presence of a gas atmosphere 7 can be confirmed from the outside of the straw (see FIG. 2(a): hydrogen-containing water 6, gas atmosphere 7) or the manner in which the hydrogen-containing water 6 moves in the container, namely, the manner in which the gas atmosphere 7 moves can be visually confirmed from the outside of the straw (see FIG. 2(b): hydrogen-containing water 6, gas atmosphere 7) when the hydrogen-containing water product for beverage is lightly swayed up and down.

Moreover, in the hydrogen-containing water product for beverage of the present invention, the hydrogen-containing water to be filled has an oxidation-reduction potential of {[−59×(pH value of hydrogen-containing water in hydrogen-containing water product for beverage after elapse of 90 days)]−170} mV or less when being stored at normal temperature for at least 90 days after manufacture. For example, in the hydrogen-containing water product for beverage of the present invention, the oxidation-reduction potential of the hydrogen-containing water is −583 mV or less in a case in which the pH1 of the hydrogen-containing water filled in the hydrogen-containing water product for beverage is 7.0 after the elapse of 90 days. In the more preferred hydrogen-containing water product for beverage of the present invention, the hydrogen-containing water to be filled has an oxidation-reduction potential of {[−59×(pH value of hydrogen-containing water in hydrogen-containing water product for beverage after elapse of 90 days)]−180} mV or less when being stored at normal temperature for at least 90 days after manufacture. In a particularly preferred aspect, the oxidation-reduction potential is {[−59×(pH value of hydrogen-containing water in hydrogen-containing water product for beverage after elapse of 90 days)]−190} mV or less.

In the hydrogen-containing water product for beverage of the present invention, the oxidation-reduction potential of the hydrogen-containing water to be filled satisfies the formulas described above when being stored at normal temperature for at least 90 days after manufacture. At the same time, the sound that the hydrogen-containing water hits the inner wall of the container is generated when the product is lightly shaken up and down after the elapse of 90 days, and the presence of a gas atmosphere is thus confirmed.

Here, the value of the oxidation-reduction potential (ORP) defined in the present invention refers to the value (vs. Ag/AgCl) measured on the basis of the silver-silver chloride electrode. The potential of the silver-silver chloride electrode (Ag/AgCl) with respect to the standard hydrogen electrode (SHE) is +0.199 V (vs. SHE) at 25° C.

The container with a straw to be used in the hydrogen-containing water product for beverage of the present invention is not particularly limited. For example, a bag-shaped container in which a tubular straw is mounted to a bag-shaped container body exhibiting flexibility and a sealing cap is attached to the opening (namely, suction portion: spout) of the straw, a container in the form of a so-called “aluminum pouch” are used.

As such a container body, for example, a container body made of an aluminum laminate film, a so-called pouch container is preferably used since it is highly airtight and can prevent the outflow of hydrogen. As the shape of the pouch container, it is possible to use various types of containers such as a gazette type (with a gusset) container and a stand type (without a gusset) container that are already on the market.

As the straw to be used in the container, it is desirable to use a barrier spout with a straw that is manufactured by using a barrier material.

The product volume of the container is not particularly limited, but for example, it is possible to suitably use a container having a volume of about from 100 mL to 2,000 mL, particularly from 150 mL to 550 mL, and specifically about 150 mL, 180 mL, 200 mL, 220 mL, 250 mL, 280 mL, 300 mL, 350 mL, 400 mL, 450 mL, 500 mL, or 550 mL. Incidentally, the term “product volume” in the present specification refers to the standard volume (also referred to as a proper amount filled or a content amount displayed) when a product is distributed and sold. It is usually several % to about 15% less than the maximum volume that can be filled in the container.

Incidentally, the size (diameter) of the cap and water inlet (spout) is approximately constant regardless of the product volume. Hence, the contact area of hydrogen gas that is generated by the heat treatment and accumulates in the vicinity of the cap and spout with the hydrogen-containing water in the container is smaller in the case of a product with a large volume such as 500 mL or 550 mL as compared to a product with a small volume (150 mL, 200 mL, or the like). Accordingly, re-dissolution of hydrogen gas in the product into the hydrogen-containing water takes place more slowly in such a large-volume product as compared to a small-volume product. Hence, in the case of a large-volume product, the hydrogen gas atmosphere remains for a long period of time not only in the hydrogen-containing water product for beverage of the present invention but also in a conventional hydrogen-containing water product for beverage filled at atmospheric pressure. Large-volume products attract attention since they can maintain a higher dissolved hydrogen concentration for a long period of time as compared to small-volume products and thus exhibit excellent long-term storability. However, in the case of a conventional hydrogen-containing water product for beverage, usually the hydrogen gas atmosphere substantially disappears in about 3 months even in such a large-volume product and it is difficult to maintain a state in which the hydrogen-containing water and the gas atmosphere are continuously present together in the container as in the hydrogen-containing water product for beverage of the present invention.

Incidentally, hydrogen-containing water is also provided as a product filled in metal cans such as aluminum or steel pull-tab cans and bottle cans in addition to the container with a straw targeted by the present invention. The pull-tab can among the products filled in these metal cans is required to be drunk at once since it cannot be recapped, the hydrogen-containing water is continuously brought into contact with the air once it is opened, and the dissolved hydrogen concentration in the hydrogen-containing water decreases with the elapse of time. In the case of a bottle can, it is possible to recap the bottle can when the product is too much to be drunk but the dissolved hydrogen concentration in the hydrogen-containing water eventually decreases since it is impossible to recap the bottle while removing the air that has flowed into the can.

On the other hand, in the case of the present invention, it is possible to recap the container with a straw while suppressing remaining of the air in the container body as much as possible by fitting the cap while causing the hydrogen-containing water to overflow as well as releasing the internal air by pressing the container body of the container with a straw from both sides even when the container with a straw is once opened. Hence, it is possible to suppress a decrease in dissolved hydrogen concentration in the hydrogen-containing water low as compared to a metal can even in a case in which the hydrogen-containing water is left over.

In addition, it is more difficult to drink the product at once as the product volume increases, for example, a large-volume product having a product volume of 550 mL, or the like, and it is thus assumed that the product is drunk by being divided into plural times. In a product using a container with a straw, it is difficult to decrease the residual air in the container body to zero, for example, even if the cap is fitted while causing the internal hydrogen-containing water to overflow every time the product is drunk (every time the cap is opened). It is thus inevitable that the dissolved hydrogen concentration decreases every time the cap is opened. As described above, a hydrogen-containing water product with a large volume has a merit that it exhibits excellent long-term storability, but the merit is lost when the product is once opened. A product is thus desired in which a decrease in dissolved hydrogen concentration is small even in the case of repeating opening and recapping of the product plural times.

In response to this demand, the present invention is able to provide a product in which the dissolved hydrogen concentration in hydrogen-containing water during the storage period is maintained higher than that of a conventional product by filling the hydrogen-containing water in a container under pressure. It is thus possible to maintain the dissolved hydrogen concentration at a relatively high concentration even after the cap is opened and closed plural times.

As described above, the hydrogen-containing water product for beverage of the present invention is a highly appealing product to consumers in that it can be drunk by being divided into plural times while maintaining a high dissolved hydrogen concentration.

The kind of hydrogen-containing water to be used in the hydrogen-containing water product for beverage of the present invention, namely, the manufacturing method thereof is not particularly limited. For example, it is possible to use those obtained by various methods such as a bubbling method in which hydrogen gas supplied from a gas cylinder is dissolved in raw water, an electrolysis method in which hydrogen gas generated by electrolysis of water is dissolved, and a membrane dissolution method using a hollow fiber membrane.

Among them, hydrogen-containing water manufactured by using a membrane dissolution method in which the residual gas is degassed from the water to be the raw material through a hollow fiber membrane, subsequently the degassed water thus obtained and pressurized hydrogen gas are introduced into a gas permeable membrane module, and the hydrogen gas is dissolved in the degassed water is preferable since the dissolved hydrogen concentration can be more efficiently increased (see, for example, prior patent applications filed by the present inventors: specification of JP 4551964 B1, PCT/JP2015/062895, and the like).

Incidentally, the dissolved hydrogen concentration in the hydrogen-containing water after being manufactured, for example, the dissolved hydrogen concentration in the hydrogen-containing water when being filled in a packaging container with a straw to be described later under pressure is preferably as high as possible. For example, it is desirably a concentration equal to or higher than the saturated hydrogen concentration in water at the temperature of the hydrogen-containing water at the time of filling at atmospheric pressure. More preferably, it is a concentration higher than the saturated temperature by 0.4 ppm (for example, 2.0 ppm or more when the water temperature is 20° C.). In particular, it is desirably a concentration higher than the saturated concentration by 0.8 ppm or more (for example, 2.4 ppm or more when the water temperature is 20° C.).

The hydrogen-containing water product for beverage of the present invention is manufactured by filling hydrogen-containing water in a packaging container with a straw under pressure, sealing the container, and then subjecting the product thus obtained to a heat treatment. In detail, it is manufactured through a filling step of filling hydrogen-containing water in a packaging container with a straw having a sealing cap attached to the opening under pressure, a sealing step of sealing the opening of the packaging container with a straw in which the hydrogen-containing water is filled with the sealing cap, and a heat treatment step of subjecting the filled and sealed product to a heat treatment.

Here, the filling (filling step) of the hydrogen-containing water in the packaging container with a straw can be conducted by the method described in, for example, PCT/JP2015/062895. As an example, it is preferable to conduct the filling by firstly removing the gas in the packaging container through suction and injecting hydrogen-containing water into this packaging container at an appropriate load pressure, for example, from 0.1 MPa to 0.5 MPa. Incidentally, the load pressure is preferably from 0.1 MPa to 0.4 MPa, and for example, it can be set to from 0.1 MPa to 0.3 MPa. Here, the load pressure refers to a pressure that is further applied in addition to atmospheric pressure (about 0.1 MPa). However, it is not preferable that the load pressure is too high to exceed 0.5 MPa since it is concerned that the too high load pressure leads to damage or breakdown of the apparatus (pipes, packing, instruments, and the like) for manufacturing hydrogen-containing water and it is thus required to pay attention. In addition, it is concerned that the filtration membrane is damaged by the too high load pressure in the case of installing a filtration membrane for removing foreign matters in the manufacturing apparatus. Furthermore, it is concerned that the hollow fiber membrane is damaged in the same manner as the above-mentioned filtration membrane in the case of manufacturing hydrogen-containing water by a membrane dissolution method using a hollow fiber membrane. It is thus desirable to set the maximum value of the load pressure to about 0.5 MPa in consideration of the occurrence of such troubles in the manufacturing apparatus.

As described above, the present invention is able to fill and seal hydrogen-containing water in a container while maintaining a higher dissolved hydrogen concentration as compared to the existing technology by employing a method in which hydrogen-containing water is filled in a packaging container in a pressurized state. Hence, it is possible to maintain a high dissolved hydrogen concentration for a long period of time as the dissolved hydrogen concentration in the filled hydrogen-containing water does not substantially decrease over a long period of time unlike the existing technology even in a case in which the residual gas in the packaging container remains as it is or other gases are mixed in the hydrogen-containing water.

In addition, the heat treatment conditions in the heat treatment step can be appropriately determined by taking the F value (the time required to kill a certain number of specific bacterial spores or bacteria at a certain temperature: usually the sterilization time (minutes) at the reference temperature (250° F.)) and the product quality into consideration. For example, the heat treatment step can be carried out under conditions having a heating temperature of from 85° C. to 90° C. and a heating time of from 20 minutes to 1 hour. For example, a heating temperature of 85° C. and a heating time of 30 minutes can be employed.

In the hydrogen-containing water product for beverage of the present invention, it is possible to fill and seal hydrogen-containing water in a container while maintaining a higher dissolved hydrogen concentration by filling the hydrogen-containing water in a packaging container with a straw under pressure. It is thus possible to maintain a higher dissolved hydrogen concentration as compared to the existing technology even if there are various gases which lead to a decrease in dissolved hydrogen concentration in the case of being in contact with the hydrogen-containing water in the container, namely, a gas remaining in the container or a gas mixed in the hydrogen-containing water.

In addition, by filling hydrogen-containing water having an increased dissolved hydrogen concentration in the container, the amount of hydrogen gas vaporized due to the saturated hydrogen concentration decreased by the heat treatment increases as compared to the case of using hydrogen-containing water having a lower dissolved hydrogen concentration. Hence, the hydrogen-containing water product for beverage of the present invention is in a state in which the hydrogen-containing water and the gas atmosphere containing hydrogen gas are present together in the container (the presence of the gas atmosphere can be confirmed as the sound that the hydrogen-containing water hits the inner wall of the container is generated when the product is lightly shaken up and down) even when being stored for a long period of time, for example, at least about 90 days at normal temperature (20° C.±15° C.) after the heat treatment and cooling. As a result, re-dissolution of the vaporized hydrogen gas in hydrogen-containing water can be achieved. In addition, vaporization of hydrogen in the hydrogen-containing water is suppressed even in a case in which the air from the outside is mixed in the hydrogen-containing water since the partial pressure of hydrogen gas in the gas atmosphere in the container is high. Hence, dissolution of oxygen or nitrogen due to the mixed air in water is suppressed. Incidentally, in the hydrogen-containing water product for beverage of the present invention, it is possible to prevent the hydrogen-containing water from dashing out when the cap is opened at the time of drinking the product by the presence of this gas atmosphere. It is concerned that hydrogen-containing water dashes out of the can at the time of drinking in the case of filling hydrogen-containing water in a pull-tab can made of a metal can such as an aluminum can or a steel can, and thus not only the amount of drinkable hydrogen-containing water decreases but water is splashed on the clothes, desk, and the like of the drinker and get wet. In the present invention, such a trouble can be eliminated by this.

By such a mechanism, the present invention has realized hydrogen-containing water having a lower oxidation-reduction potential as compared to a conventional product even when 90 days elapse after manufacture in the hydrogen-containing water product for beverage. Moreover, according to the present invention, it is possible to provide hydrogen-containing water maintaining high quality, for example, the oxidation-reduction potential of hydrogen-containing water having a pH of 7.0 is about −600 mV or less and the dissolved hydrogen concentration therein is 1.0 ppm or more, for example, even when 180 days or longer elapse after manufacture.

### EXAMPLES

Desirable embodiments of the present invention will be described more specifically, but the present invention is not limited thereto.

### Example 1 and Comparative Example 1: Manufacture (1) of Hydrogen-Containing Water Product for Beverage

Hydrogen-containing water products for beverage to be used in Examples were manufactured by the following procedures, respectively.

1) Hydrogen-containing water product for beverage manufactured by filling hydrogen-containing water under pressure:

In the present Example, a hydrogen-containing water product for beverage was manufactured through a filling step of filling hydrogen-containing water in a packaging container with a straw having a sealing cap attached to the opening under pressure, a sealing step of sealing the opening of the packaging container with a straw in which the hydrogen-containing water was filled with the sealing cap, and a heat treatment step of subjecting the filled and sealed product to a heat treatment.

More specifically, the hydrogen-containing water product for beverage was manufactured according to the method disclosed in the prior patent applications (specification of JP 4551964 B1 and PCT/JP2015/062895) by the present inventors. In other words, the hydrogen-containing water product for beverage of Example 1 was manufactured through (1) a purification step of filtering and purifying water to be the raw material in a purification apparatus and sending the purified water thus obtained to a degassing apparatus; (2) a degassing step of degassing the purified water thus supplied through the hollow fiber membrane in the degassing apparatus and sending the degassed water thus obtained to a hydrogen dissolving apparatus; (3) a hydrogen dissolving step of dissolving pressurized hydrogen gas in the degassed water thus supplied through the hollow fiber membrane in the hydrogen dissolving apparatus and sending the hydrogen-containing water thus obtained to a filling apparatus; (4) a filling step of filling the hydrogen-containing water thus supplied in a packaging container with a straw through its opening (injection port) in the filling apparatus; (5) a sealing step of sealing the opening of the packaging container with a straw in which the hydrogen-containing water was filled with a sealing cap, and (6) a step of subjecting a product in which hydrogen-containing water was filled and sealed to a heat treatment (at 85° C. for 30 minutes). Incidentally, at this time, the filling step (4) was carried out by filling under pressure (load pressure: from 0.2 MPa to 0.3 MPa (pressurized state of 0.2 MPa to 0.3 MPa higher than atmospheric pressure)).

Incidentally, hydrogen-containing water to which a pressure had been loaded was supplied to the filling apparatus by loading a pressure (the load pressure: from 0.2 MPa to 0.3 MPa) to the water passage from the purified water to be supplied to the degassing apparatus in the degassing step (2) to the hydrogen-containing water to be injected into the packaging container in the filling step (4) by the operation of a pressure pump.

In addition, the hydrogen-containing water product for beverage was manufactured such that the filling step (4), in more detail, consisted of a step (hereinafter, the present step was simply referred to as the “filling under pressure”) which included

a preparation stage of closing the filling port of the filling apparatus by the shaft valve and then bringing the hydrogen-containing water to which a pressure was loaded and which was sent from the hydrogen dissolving step (3) into a state of being supplied into the cavity in contact with the filling port;

a degassing stage of connecting the injection port of the packaging container to the filling port and subsequently removing the gas in the packaging container through a gas passage provided to the shaft valve by a gas pressure reducing means;

an injection stage of closing the gas passage, opening the filling port by the shaft valve, and injecting the hydrogen-containing water to which a pressure was loaded directly into the packaging container; and

a discharge step of discharging the hydrogen-containing water remaining in the filling apparatus into the packaging container by closing the filling port by the shaft valve, then opening the gas passage, and introducing pressurized air into the cavity through the gas passage by a gas pressurizing means, and

immediately transferring to the sealing step (5) when the injection port and the filling port were disconnected from each other.

Incidentally, the hydrogen-containing water product for beverage of Example 1 thus obtained was lightly shaken when 7 days, 14 days, and 30 days elapsed after manufacture, and after the elapse of every 30 days thereafter until 180 days elapsed (stored at room temperature (25° C.±5° C.) and the same applies to Comparative Example 1). The sound was confirmed in every case. This demonstrates the presence of a gas atmosphere in the space above the hydrogen-containing water filled in the container.

2) Hydrogen-containing water product for beverage manufactured by filling hydrogen-containing water at atmospheric pressure:

Hydrogen gas was formed into fine bubbles and dissolved in raw water by introducing the fine bubbles into the raw water. The hydrogen-containing water thus obtained was filled in a packaging container with a straw at atmospheric pressure, the opening (injection port) of the packaging container with a straw in which the hydrogen-containing water was filled was then sealed, and a product in which the hydrogen-containing water was filled and sealed was subjected to a heat treatment (at 85° C. for 30 minutes), thereby manufacturing the hydrogen-containing water product for beverage of Comparative Example 1.

Incidentally, with regard to the filling, in more detail, first, a certain amount of hydrogen-containing water was weighed by temporarily storing the hydrogen-containing water manufactured above in a hydrogen-containing water tank and then lowering the piston of the metering apparatus connected to the hydrogen-containing water tank. Here, the gas remaining in the packaging container was sucked and removed through the gas passage in the shaft valve of the filling apparatus before filling of the hydrogen-containing water was started. Thereafter, the hydrogen-containing water was filled in the packaging container through the filling port by synchronously raising the shaft valve of the filling apparatus and the piston of the metering apparatus (hereinafter, the present step is simply referred to as the “filling at normal pressure”).

The hydrogen-containing water product for beverage of Comparative Example 1 thus obtained was lightly shaken in the same manner as in Example 1. The sound was confirmed immediately after manufacture (after heat treatment/cooling treatment), but the sound was not confirmed any longer after the elapse of 14 days, thereafter, the sound was not confirmed even though a period of time elapsed. This indicates that a gas atmosphere is not present in the space above the hydrogen-containing water filled in the container. In other words, this is because the movement of hydrogen-containing water in the container is restricted.

Incidentally, in any of examples, a container having a product volume of 150 mL was used as a packaging container with a straw. The hydrogen-containing water product for beverage was filled in this container in an amount of 150 g±5 g. The following evaluations were conducted for five product samples on the following every measurement day.

In addition, the saturated hydrogen concentration at 20° C. and 1 atm is 1.6 ppm.

<Evaluation (1) of Hydrogen-Containing Water Product for Beverage>

The dissolved hydrogen concentration, pH, and oxidation-reduction potential (vs. Ag/AgCl)) of the hydrogen-containing water products for beverage of Example 1 and Comparative Example 1 were measured when 30 days, 60 days, 90 days, 120 days, 150 days, and 180 days elapsed (stored at room temperature (25° C.±5° C.)) after manufacture.

The results thus obtained are presented in Table 1 and Table 2.

Incidentally, the values calculated by the following formulas are presented in Table 1 and Table 2 as the calculated ORP value for reference.

Calculated ORP value A: {[−59×(measured pH value of hydrogen-containing water in hydrogen-containing water product for beverage)]−170} mV

Calculated ORP value B: {[−59×(measured pH value of hydrogen-containing water in hydrogen-containing water product for beverage)]−180} mV

TABLE 1

| | | | | Reference: | |
|---|---|---|---|---|---|
| | Dissolved | | | calculated | |
| | hydrogen | | Oxidation-reduction | ORP | |
| | concentration | | potential* | value (mV) | |
| Example 1 | dH (ppm) | pH | ORP (mV) | A | B |
| Product after | 1.58 | 6.96 | −613 | | |
| elapse of 30 | 1.56 | 6.95 | −612 | | |
| days | 1.59 | 6.95 | −612 | | |
| | 1.60 | 6.95 | −613 | | |
| | 1.59 | 6.95 | −613 | | |
| Product after | 1.32 | 6.97 | −610 | | |
| elapse of 60 | 1.39 | 6.95 | −609 | | |
| days | 1.44 | 6.96 | −608 | | |
| | 1.40 | 6.94 | −608 | | |
| | 1.38 | 6.96 | −609 | | |
| Product after | 1.22 | 6.93 | −608 | −579 | −589 |
| elapse of 90 | 1.36 | 6.92 | −607 | −578 | −588 |
| days | 1.34 | 6.91 | −607 | −578 | −588 |
| | 1.31 | 6.91 | −606 | −578 | −588 |
| | 1.33 | 6.92 | −608 | −578 | −588 |
| Product after | 1.28 | 6.90 | −606 | | |
| elapse of 120 | 1.24 | 6.90 | −606 | | |
| days | 1.25 | 6.95 | −607 | | |
| | 1.28 | 6.94 | −607 | | |
| | 1.27 | 6.92 | −606 | | |
| Product after | 1.14 | 6.93 | −604 | | |
| elapse of 150 | 1.15 | 6.93 | −604 | | |
| days | 1.17 | 6.93 | −604 | | |
| | 1.13 | 6.92 | −604 | | |
| | 1.17 | 6.91 | −604 | | |
| Product after | 1.02 | 6.91 | −601 | | |
| elapse of 180 | 1.04 | 6.91 | −602 | | |
| days | 1.04 | 6.91 | −602 | | |
| | 1.02 | 6.90 | −601 | | |
| | 1.05 | 6.91 | −602 | | |

*vs. Ag/AgCl [+0.199V (vs. SHE, 25° C.)]

TABLE 2

| | | | | Reference: | |
|---|---|---|---|---|---|
| | Dissolved | | | calculated | |
| | hydrogen | | Oxidation-reduction | ORP | |
| Comparative | concentration | | potential* | Value (mV) | |
| Example 1 | dH (ppm) | pH | ORP (mV) | A | B |
| Product after | 1.09 | 6.72 | −588 | | |
| elapse of 30 | 1.12 | 6.71 | −588 | | |
| days | 1.10 | 6.71 | −588 | | |
| | 1.13 | 6.72 | −589 | | |
| | 1.08 | 6.72 | −589 | | |
| Product after | 0.87 | 6.69 | −583 | | |
| elapse of 60 | 0.87 | 6.70 | −585 | | |
| days | 0.88 | 6.70 | −585 | | |
| | 0.83 | 6.69 | −584 | | |
| | 0.84 | 6.69 | −584 | | |
| Product after | 0.70 | 6.64 | −578 | −562 | −572 |
| elapse of 90 | 0.61 | 6.64 | −573 | −562 | −572 |
| days | 0.60 | 6.70 | −577 | −565 | −575 |
| | 0.65 | 6.70 | −579 | −565 | −575 |
| | 0.60 | 6.68 | −576 | −564 | −574 |
| Product after | 0.33 | 6.67 | +162 | | |
| elapse of 120 | 0.38 | 6.67 | +144 | | |
| days | 0.30 | 6.68 | +198 | | |
| | 0.34 | 6.65 | +175 | | |
| | 0.31 | 6.68 | +201 | | |
| Product after | 0.25 | 6.67 | +251 | | |
| elapse of 150 | 0.16 | 6.68 | +268 | | |
| days | 0.18 | 6.68 | +234 | | |
| | 0.15 | 6.68 | +259 | | |
| | 0.16 | 6.67 | +243 | | |
| Product after | 0.05 | 6.64 | +286 | | |
| elapse of 180 | 0.13 | 6.64 | +242 | | |
| days | 0.09 | 6.65 | +280 | | |
| | 0.07 | 6.66 | +277 | | |
| | 0.06 | 6.64 | +281 | | |

*vs. Ag/AgCl [+0.199V (vs. SHE, 25° C.)]

### Example 2 and Comparative Example 2: Manufacture (2) of Hydrogen-Containing Water Product for Beverage

Hydrogen-containing water products for beverage of Example 2 and Comparative Example 2 were manufactured according to the [1) hydrogen-containing water product for beverage manufactured by filling hydrogen-containing water under pressure] and [2) hydrogen-containing water product for beverage manufactured by filling hydrogen-containing water at atmospheric pressure] except that a container having a product volume of 500 mL, was used as a packaging container with a straw and the hydrogen-containing water product for beverage was filled in this container in an amount of 500 g±5 g.

Incidentally, the hydrogen-containing water product for beverage of Example 2 thus obtained was lightly shaken after the elapse of every evaluation period (from 60 days up to 180 days) to be described later (stored at room temperature (25° C.±5° C.) and the same applies to Comparative Example 2), and the sound that the hydrogen-containing water hit the inner wall of the container was confirmed in every case.

In addition, the hydrogen-containing water product for beverage of Comparative Example 2 was lightly shaken in the same manner. The sound was confirmed immediately after manufacture (heat treatment). There were products from which the sound was slightly confirmed after the elapse of 60 days. However, the sound was not confirmed at all from any product after the elapse of 90 days. Thereafter, the sound was not confirmed even though a period of time elapsed.

<Evaluation (2) of Hydrogen-Containing Water Product for Beverage>

The dissolved hydrogen concentration, pH, and oxidation-reduction potential (vs. A g/AgCl)) of the hydrogen-containing water products for beverage of Example 2 and Comparative Example 2 were measured when 30 days, 60 days, 90 days, and 180 days elapsed (stored at room temperature (25° C.±5° C.)) after manufacture.

The results thus obtained are presented in Table 3 and Table 4. The calculated ORP value was calculated in the same manner as the above and is also presented in Table 3 and Table 4.

TABLE 3

| | | | | Reference: | |
|---|---|---|---|---|---|
| | Dissolved | | | calculated | |
| | hydrogen | | Oxidation-reduction | ORP | |
| | concentration | | potential* | Value (mV) | |
| Example 2 | dH (ppm) | pH | ORP (mV) | A | B |
| Product after | 1.59 | 7.10 | −623 | | |
| elapse of 30 | 1.57 | 7.10 | −624 | | |
| days | 1.59 | 7.11 | −624 | | |
| | 1.57 | 7.10 | −623 | | |
| | 1.60 | 7.11 | −625 | | |
| Product after | 1.54 | 7.03 | −617 | | |
| elapse of 60 | 1.53 | 7.08 | −619 | | |
| days | 1.53 | 7.08 | −620 | | |
| | 1.54 | 7.11 | −623 | | |
| | 1.54 | 7.10 | −622 | | |
| Product after | 1.49 | 7.05 | −615 | −586 | −596 |
| elapse of 90 | 1.50 | 7.08 | −618 | −588 | −598 |
| days | 1.45 | 7.04 | −614 | −585 | −595 |
| | 1.51 | 7.07 | −618 | −587 | −597 |
| | 1.52 | 7.06 | −617 | −587 | −597 |
| Product after | 1.55 | 7.07 | −614 | | |
| elapse of 120 | 1.40 | 7.10 | −616 | | |
| days | 1.42 | 7.09 | −617 | | |
| | 1.40 | 7.10 | −618 | | |
| | 1.46 | 7.10 | −619 | | |
| Product after | 1.38 | 7.05 | −612 | | |
| elapse of 150 | 1.38 | 7.06 | −612 | | |
| days | 1.36 | 7.07 | −613 | | |
| | 1.38 | 7.07 | −613 | | |
| | 1.35 | 7.07 | −614 | | |
| Product after | 1.29 | 7.05 | −610 | | |
| elapse of 180 | 1.33 | 7.05 | −610 | | |
| days | 1.33 | 7.06 | −610 | | |
| | 1.30 | 7.05 | −610 | | |
| | 1.34 | 7.04 | −609 | | |

*vs. Ag/AgCl [+0.199V (vs. SHE, 25° C.)]

TABLE 4

| | | | | Reference: | |
|---|---|---|---|---|---|
| | Dissolved | | | calculated | |
| | hydrogen | | Oxidation-reduction | ORP | |
| Comparative | concentration | | potential* | value (mV) | |
| Example 2 | dH (ppm) | pH | ORP (mV) | A | B |
| Product after | 1.13 | 7.10 | −612 | | |
| elapse of 30 | 1.15 | 7.09 | −611 | | |
| days | 1.17 | 7.08 | −611 | | |
| Product after | 0.94 | 7.09 | −608 | | |
| elapse of 60 | 0.92 | 7.09 | −608 | | |
| days | | | | | |
| | 0.92 | 7.09 | −608 | | |
| Product after | 0.75 | 7.08 | −599 | −588 | −598 |
| elapse of 90 | 0.74 | 7.10 | −599 | −589 | −599 |
| days | 0.75 | 7.09 | −595 | −588 | −598 |
| Product after | 0.50 | 7.12 | −490 | | |
| elapse of 120 | 0.47 | 7.13 | −476 | | |
| days | 0.48 | 7.13 | −477 | | |
| Product after | 0.36 | 7.13 | +123 | | |
| elapse of 150 | 0.36 | 7.12 | +135 | | |
| days | 0.33 | 7.12 | +108 | | |
| Product after | 0.24 | 7.12 | +233 | | |
| elapse of 180 | 0.20 | 7.12 | +226 | | |
| days | 0.21 | 7.12 | +228 | | |

*vs. Ag/AgCl [+0.199V (vs. SHE, 25° C.)]

As presented in Table 1, the hydrogen-containing water product for beverage of the present invention (Example 1) had an oxidation-reduction potential of from −606 to −608 mV at a pH of from 6.91 to 6.93 when 90 days elapsed after manufacture. In other words, the product was able to maintain not only the quality that the value of the oxidation-reduction potential was equal to or less than the calculated value of from −578 to 579 mV by the formula <{[−59×(pH value of hydrogen-containing water in hydrogen-containing water product for beverage after elapse of 90 days)]−170} mV> but also the quality that the value of the oxidation-reduction potential was equal to or less than the calculated value of from −588 to 589 mV by the formula <{[−59×(pH value of hydrogen-containing water in hydrogen-containing water product for beverage after elapse of 90 days)]−180} mV>. Furthermore, although it is not presented in Table 1, the product was able to maintain the quality that the value of the oxidation-reduction potential was equal to or less than the calculated value of from −598 to 599 mV by the formula <{[−59×(pH value of hydrogen-containing water in hydrogen-containing water product for beverage after elapse of 90 days)]−190} mV> as well. In detail, the actually measured value was lower than the calculated value even by from 19 mV to 20 mV. Furthermore, the product was able to maintain high quality that the oxidation-reduction potential of hydrogen-containing water was −600 mV or less and the dissolved hydrogen concentration was 1.00 ppm or more at a pH of from 6.90 to 6.91 even after the elapse of 180 days.

On the other hand, in the hydrogen-containing water product for beverage of Comparative Example 1, the sound was not confirmed when 14 days elapsed after manufacture and a gas atmosphere was not present in the container. In addition, as presented in Table 2, the dissolved hydrogen concentration was already around 1.10 ppm when 30 days elapsed after manufacture, and it was at the same level as that after the elapse of 180 days in Example 1. The dissolved hydrogen concentration decreased to around 0.65 ppm when 90 days elapsed after manufacture, and it was confirmed that the rate of decrease in dissolved hydrogen concentration was faster as compared to Example 1. Incidentally, the hydrogen-containing water product after the elapse of 90 days had an oxidation-reduction potential of from −573 to −579 mV at a pH of from 6.64 to 6.70, and the calculated value of oxidation-reduction potential by the formula <{[−59×(pH value of hydrogen-containing water in hydrogen-containing water product for beverage after elapse of 90 days)]−180} mV> was from −572 to 575 mV. As described above, although the actually measured value of the oxidation-reduction potential was lower than the favorable calculated value, the difference is about from 1 mV to 6 mV, which is far from the results of Example 1. Furthermore, although it is not presented in Table 2, the product did not attain the quality that the oxidation-reduction potential was equal to or less than the calculated value of from −582 to 585 mV by the formula <{[−59×(pH value of hydrogen-containing water in hydrogen-containing water product for beverage after elapse of 90 days)]−190} mV>.

As described above, in Comparative Example 1, the oxidation-reduction potential after the elapse of 90 days was maintained at a lower value than the value calculated by the above calculation formula. However, the sound was not confirmed any longer when the product was shaken after the elapse of 14 days, that is, a gas atmosphere was not present in the container at this time point. It is considered that this has led to a remarkable decrease in dissolved hydrogen concentration on and after the 90th day. Moreover, the product of Comparative Example 1 was greatly inferior in quality to the hydrogen-containing water product for beverage of the present invention (Example 1) as the oxidation-reduction potential was a positive value after the elapse of 120 days, for example.

As described above, in a case in which a gas atmosphere is present in the container, it is possible to maintain the partial pressure of hydrogen gas in the entire atmosphere pressure in a high state even when the air gradually enters the container through the vicinity of the cap or straw of which the airtightness is not perfect. Hence, the vaporization of hydrogen dissolved in the hydrogen-containing water is suppressed and dissolution of the air in the hydrogen-containing water is also suppressed.

On the other hand, in a case in which a gas atmosphere is not present in the container, the air and hydrogen-containing water come in direct contact with each other when the air enters the container, and dissolution of entrained air in the hydrogen-containing water easily proceeds. This expels the hydrogen gas dissolved in hydrogen-containing water from the hydrogen-containing water as a gas, and dissolution of the air in the hydrogen-containing water further proceeds. Hence, the dissolved hydrogen concentration decreases and the oxidation-reduction potential turns to a positive value by the dissolution of oxygen in the air.

As described above, it is significantly important for maintaining high quality of the hydrogen-containing water product for beverage of the present invention that the hydrogen-containing water product has a gas atmosphere in the container even after being stored for a certain period of time and, moreover, the hydrogen-containing water in the product maintains a low oxidation-reduction potential (to be lower than the calculated value calculated by a specific calculation formula).

In addition, in the case of a product having a product volume of 500 mL, as presented in Table 3, the hydrogen-containing water product for beverage of the present invention (Example 2) had an oxidation-reduction potential of from −614 to −618 mV at a pH of from 7.04 to 7.08 when 90 days elapsed after manufacture in the same manner as in Example 1. An actually measured value lower than the calculated value of from −595 to −598 mV by the formula <{[−59×(pH value of hydrogen-containing water in hydrogen-containing water product for beverage after elapse of 90 days)]−180} mV> by from 19 mV to 210 mV was measured. Furthermore, although it is not presented in Table 3, the product was able to maintain the quality that the oxidation-reduction potential was equal to or less than the calculated value of from −605 to 608 mV by the formula <{[−59×(pH value of hydrogen-containing water in hydrogen-containing water product for beverage after elapse of 90 days)]−190} mV> as well. In addition, the dissolved hydrogen concentration was maintained at a high level to be a little less than 1.6 ppm when 30 days elapsed after manufacture and around 1.50 ppm when 90 days elapsed. Furthermore, the product was able to maintain a significantly high quality that the oxidation-reduction potential of hydrogen-containing water was about −610 mV and the dissolved hydrogen concentration was about 1.30 ppm or more at a pH of from 7.04 to 7.06 even after the elapse of 180 days.

On the other hand, in the hydrogen-containing water product for beverage of Comparative Example 2, the sound was not confirmed when 90 days elapsed after manufacture, and a gas atmosphere was not present in the container. Moreover, as presented in Table 4, the oxidation-reduction potential (actually measured value) at a pH of from 7.08 to 7.10 was from −595 to −599 mV when 90 days elapsed after manufacture, and it was approximately the same value as the calculated value by the formula <{[−59×(pH value of hydrogen-containing water in hydrogen-containing water product for beverage after elapse of 90 days)]−180} mV>. In addition, although it is not presented in Table 4, the product did not attain the quality that the oxidation-reduction potential was equal to or less than the calculated value (−608 to 609 mV) by the formula <{[−59×(pH value of hydrogen-containing water in hydrogen-containing water product for beverage after elapse of 90 days)]−190} mV>. In addition, the dissolved hydrogen concentration was already around 1.15 ppm when 30 days elapsed after manufacture, and it was already lower than that (about 1.30 ppm) after the elapse of 180 days in Example 2. The dissolved hydrogen concentration was about 0.75 ppm after the elapse of 90 days and about 0.22 ppm after the elapse of 180 days, and it was confirmed that the rate of decrease in dissolved hydrogen concentration was significantly faster as compared to Example 2. As described above, even in the 500 mL product, the product of Comparative Example was inferior in quality to the hydrogen-containing water product for beverage of the present invention.

### Example 3 and Comparative Example 3: Evaluation (3) of Hydrogen-Containing Water Product for Beverage

The hydrogen-containing water product for beverage of Example 3 was manufactured according to the manufacturing methods of Example 1 (product volume of 150 mL) and Example 2 (product volume of 500 mL), and the hydrogen-containing water product for beverage of Comparative Example 3 was manufactured according to the methods of Comparative Example 1 (product volume of 150 mL) and Comparative Example 2 (product volume of 500 mL).

These were stored at 15° C. 25° C., or 35° C., and the product was lightly shaken when 30 days elapsed after manufacture to confirm whether the sound that the hydrogen-containing water hit the inner wall of the container was generated or not (the number of tests at each temperature: N=3). After that, the same test was conducted until 180 days elapsed to confirm the generation of sound.

The results thus obtained are presented in Tables 5 and 6. The numerical values in the tables are the number of products from which the generation of sound is confirmed with respect to the number of tests (N=3).

TABLE 5

| Example 3 | Product volume: | | | | | |
|---|---|---|---|---|---|---|
| Filling under | 150 mL | | | Product volume: 500 mL | | |
| pressure | 15° C. | 25° C. | 35° C. | 15° C. | 25° C. | 35° C. |
| Product after | 3/3 | 3/3 | 3/3 | 3/3 | 3/3 | 3/3 |
| elapse of 30 | | | | | | |
| days | | | | | | |
| Product after | 3/3 | 3/3 | 3/3 | 3/3 | 3/3 | 3/3 |
| elapse of 60 | | | | | | |
| days | | | | | | |
| Product after | 3/3 | 3/3 | 3/3 | 3/3 | 3/3 | 3/3 |
| elapse of 90 | | | | | | |
| days | | | | | | |
| Product after | 3/3 | 3/3 | 3/3 | 3/3 | 3/3 | 3/3 |
| elapse of 120 | | | | | | |
| days | | | | | | |
| Product after | 3/3 | 3/3 | 3/3 | 3/3 | 3/3 | 3/3 |
| elapse of 150 | | | | | | |
| days | | | | | | |
| Product after | 3/3 | 3/3 | 3/3 | 3/3 | 3/3 | 3/3 |
| elapse of 180 | | | | | | |
| days | | | | | | |

TABLE 6

| Comparative | | | | | | |
|---|---|---|---|---|---|---|
| Example 3 | | | | | | |
| Filling at | Product volume: | | | | | |
| normal | 150 mL | | | Product volume: 500 mL | | |
| pressure | 15° C. | 25° C. | 35° C. | 15° C. | 25° C. | 35° C. |
| Product after | 0/3 | 0/3 | 0/3 | 3/3 | 3/3 | 3/3 |
| elapse of 30 | | | | | | |
| days | | | | | | |
| Product after | 0/3 | 0/3 | 0/3 | 2/3 | 2/3 | 2/3 |
| elapse of 60 | | | | | | |
| days | | | | | | |
| Product after | 0/3 | 0/3 | 0/3 | 0/3 | 0/3 | 0/3 |
| elapse of 90 | | | | | | |
| days | | | | | | |
| Product after | 0/3 | 0/3 | 0/3 | 0/3 | 0/3 | 0/3 |
| elapse of 120 | | | | | | |
| days | | | | | | |
| Product after | 0/3 | 0/3 | 0/3 | 0/3 | 0/3 | 0/3 |
| elapse of 150 | | | | | | |
| days | | | | | | |
| Product after | 0/3 | 0/3 | 0/3 | 0/3 | 0/3 | 0/3 |
| elapse of 180 | | | | | | |
| days | | | | | | |

As presented in Tables 5 and 6, in Example 3 (product volume of 150 mL or 500 mL), the sound was confirmed even when 180 days elapsed after manufacture regardless of the product volume and the storage temperature. It was thus confirmed that a gas atmosphere was present in the container of the hydrogen-containing water product. In addition, in any of these, it was able to visually confirm the manner in which the hydrogen-containing water (or hydrogen gas atmosphere) moved in the container from the outside of the straw when the product was lightly swayed up and down (see FIG. 2 (b)).

On the other hand, in Comparative Example 3 (product volume of 150 mL or 500 mL), the sound was not confirmed at all on and after the 30th day in the case of a product volume of 150 mL. In the case of a product volume of 500 mL, the sound was confirmed after the elapse of 30 days, but there were products from which the sound was not confirmed after the elapse of 60 days. It was not able to confirm the sound from all the products after the elapse of 90 days, and as a result, a gas atmosphere was not present in the container.

### Example 4 and Comparative Example 4: Evaluation (4) of Hydrogen-Containing Water Product for Beverage

The hydrogen-containing water product for beverage of Example 4 was manufactured according to the manufacturing methods of Example 1 (product volume of 150 mL) and Example 2 (product volume of 500 mL), and the hydrogen-containing water product for beverage of Comparative Example 4 was manufactured according to the methods of Comparative Example 1 (product volume of 150 mL) and Comparative Example 2 (product volume of 500 mL). These were stored at room temperature (25° C.±5° C.).

When 60 days elapsed after manufacture, a hydrogen gas detector (“Intelligent Gas Detector GD-70D” manufactured by RIKEN KEIKI Co., Ltd., initial value: 0 ppm) was installed near the cap of each hydrogen-containing water product for beverage, and the cap of the product was turned to open (the number of products for each case: 5).

In Example 4 (product volume: 150 mL and 500 mL), the value indicated by the hydrogen gas detector exceeded 2,000 ppm of the measurement upper limit at the moment at which the cap was opened in every case. On the other hand, in Comparative Example 4 (product volume: 150 mL and 500 mL), the value indicated by the hydrogen gas detector did not change at all from the initial value (0 ppm) even after the cap was opened.

In the same manner, even when 90 days and 120 days elapsed after manufacture as well, the value indicated by the hydrogen gas detector exceeded 2,000 ppm of the upper limit as soon as the products were opened in the products of Example 4 (product volume: 150 mL and 500 mL), but the value indicated by the hydrogen gas detector after opening remained at the initial value (0 ppm) in Comparative Example 4 (product volume: 150 mL and 500 mL).

As described above, the presence of a hydrogen gas atmosphere after the elapse of 90 days was confirmed by the hydrogen gas detector in the products of Example 4, but the presence of a hydrogen gas atmosphere after the elapse of 90 days was not confirmed in the products of Comparative Example 4.

### Example 5: Evaluation of Hydrogen-Containing Water for Beverage

The hydrogen-containing water products for beverage (5 kinds) to be used for the evaluation of Example 5 were respectively manufactured according to the manufacturing method of Example 1 (product volume of 150 ml.).

However, at the time of manufacturing, the pressure loaded to the water passage from the purified water to be supplied to the degassing apparatus in the degassing step (2) to the hydrogen-containing water to be injected into the packaging container in the filling step (4) by the operation of a pressure pump and the pressure of the pressurized hydrogen gas in the hydrogen dissolving step were variously adjusted so as to comply with the following conditions.

<Condition for Pressure Adjustment of Water Passage and Hydrogen Gas>

The product immediately after filling was sampled (3 bottles), and the pH and oxidation-reduction potential (vs. Ag/AgCl) of the hydrogen-containing water in the sampled product were measured. The above pressure condition was adjusted by using the measured pH value so that the solution obtained from the following formula was ±3 mV from the measured oxidation-reduction potential value.

Calculated value (mV)=[−59×measured pH value]−α

α=160, 170, 180, 190, 200, or 210

Incidentally, the present condition means that the dissolved hydrogen concentration in the hydrogen-containing water immediately after manufacture is closer to the saturated concentration as α is larger. The condition of α=210 means that the product is manufactured under the same pressure condition as in Example 1 and the oxidation-reduction potential of the hydrogen-containing water product after the elapse of 90 days satisfies the above formula “[−59 {(pH value of hydrogen-containing water in hydrogen-containing water product for beverage after elapse of 90 days)]−170} mV or less” as to be described later.

The dissolved hydrogen concentration, pH, and oxidation-reduction potential (vs. Ag/AgCl) of five kinds of hydrogen-containing water products for beverage manufactured by the procedure (conducted in the same manner until the heat treatment step) and under the condition described above were measured when 15 days, 30 days, and 60 days elapsed (stored at room temperature (25° C.±5° C.)) after manufacture in the case of the condition of α=160 or 170 and when 15 days, 30 days, 60 days, and 90 days elapsed (stored at room temperature (25° C.±5° C.)) after manufacture in the case of the condition of α=180, 190, 200, and 210. The average value of the values measured under the respective conditions was calculated (number of products=3). The results thus obtained are presented in Tables 7 to 9. In Table 9, the values calculated by the following formulas are presented as the calculated ORP value for reference.

Calculated ORP value A: {[−59×(measured pH value of hydrogen-containing water in hydrogen-containing water product for beverage)]−170} mV

Calculated ORP value B: {[−59×(measured pH value of hydrogen-containing water in hydrogen-containing water product for beverage)]−180} mV

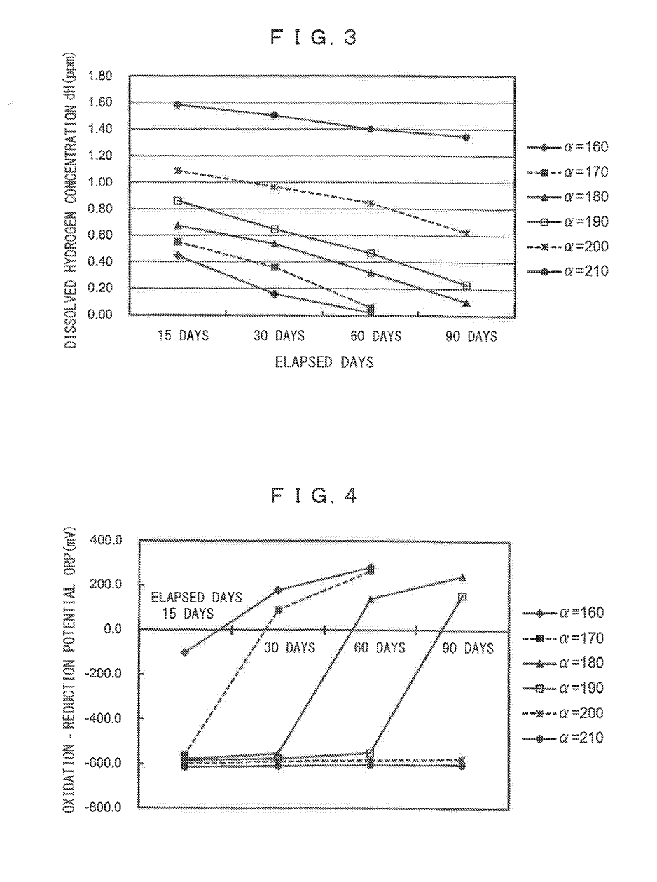

In addition, a change in dissolved hydrogen concentration and a change in oxidation-reduction potential with respect to the elapsed days are illustrated in FIG. 3 and FIG. 4, respectively.

TABLE 7
[Change of dissolved hydrogen concentration dH (ppm) with time]

| dH (ppm) | α = 160 | α = 170 | α = 180 | α = 180 | α = 200 | α = 210 |
|---|---|---|---|---|---|---|
| Product after | 0.45 | 0.55 | 0.67 | 0.86 | 1.09 | 1.58 |
| elapse of 15 | | | | | | |
| days | | | | | | |
| Product after | 0.16 | 0.36 | 0.54 | 0.65 | 0.97 | 1.50 |
| elapse of 30 | | | | | | |
| days | | | | | | |
| Product after | 0.02 | 0.06 | 0.32 | 0.47 | 0.84 | 1.40 |
| elapse of 60 | | | | | | |
| days | | | | | | |
| Product after | — | — | 0.10 | 0.23 | 0.62 | 1.35 |
| elapse of 90 | | | | | | |
| days | | | | | | |

TABLE 8
[Change of pH with time]

| pH | α = 160 | α = 170 | α = 180 | α = 180 | α = 200 | α = 210 |
|---|---|---|---|---|---|---|
| Product after | 7.05 | 7.05 | 7.03 | 6.98 | 6.88 | 6.92 |
| elapse of 15 | | | | | | |
| days | | | | | | |
| Product after | 7.07 | 7.06 | 7.05 | 6.98 | 6.88 | 6.90 |
| elapse of 30 | | | | | | |
| days | | | | | | |
| Product after | 7.09 | 7.08 | 7.06 | 7.00 | 6.90 | 6.89 |
| elapse of 60 | | | | | | |
| days | | | | | | |
| Product after | — | — | 7.08 | 7.03 | 6.90 | 6.89 |
| elapse of 90 | | | | | | |
| days | | | | | | |

TABLE 9
[Change of oxidation-reduction potential ORP (mV) with time]

| ORP (mV)* | α = 160 | α = 170 | α = 180 | α = 180 | α = 200 | α = 210 |
|---|---|---|---|---|---|---|
| Product after | −102.3 | −560.3 | −579.7 | −584.7 | −598.7 | −613.7 |
| elapse of 15 | | | | | | |
| days | | | | | | |
| Product after | 177.7 | 90.0 | −554.7 | −577.7 | −589.7 | −610.0 |
| elapse of 30 | | | | | | |
| days | | | | | | |
| Product after | 280.3 | 263.0 | 138.0 | −551.7 | −584.3 | −606.3 |
| elapse of 60 | | | | | | |
| days | | | | | | |
| Product after | — | — | 239.7 | 154.7 | −578.3 | −605.0 |
| elapse of 90 | | | | | | |
| days | | | | | | |

| | | | | | |
|---|---|---|---|---|---|
| Reference ORP value | A | −587.7 | −584.6 | −577.3 | −576.3 |
| | B | −597.7 | −594.6 | −587.3 | −586.3 |

*vs. Ag/AgCl [+0.199 V (vs. SHE, 25° C.)]

As presented in Table 9, the product having a value lower than the reference ORP value (A) among the products after the elapse of 90 days had a small amount of change in dissolved hydrogen concentration and oxidation-reduction potential with time as illustrated in FIG. 3 and FIG. 4. Particularly in the product (α=210) having a value lower than the reference ORP value (B), not only the changes in dissolved hydrogen concentration and oxidation-reduction potential with time were small, but also it was possible to maintain the dissolved hydrogen concentration at a high value. In other words, a result that the high quality was maintained was obtained. On the other hand, in other products, a result was obtained that the changes in dissolved hydrogen concentration and oxidation-reduction potential with time were large and the value of dissolved hydrogen concentration was also low.

The above results indicate that a hydrogen-containing water product for beverage having an oxidation-reduction potential of hydrogen-containing water of ({[−59×(pH value of hydrogen-containing water in hydrogen-containing water product for beverage after elapse of 90 days)]−170} mV or less when being stored at normal temperature for at least 90 days after manufacture can maintain a high dissolved hydrogen concentration and a low oxidation-reduction potential from the time immediately after manufacture until a long period of time elapses.

As described above, the hydrogen-containing water product for beverage of the present invention can provide consumers with hydrogen-containing water having stable quality for a long period of time as compared to the products of Comparative Examples.

### REFERENCE SIGNS LIST

1 . . . Hydrogen-containing water product for beverage
2 . . . Packaging container with straw
3 . . . Container body
4 . . . Straw
41 . . . Opening
5 . . . Sealing cap
6 . . . Hydrogen-containing water
7 . . . Gas atmosphere

1. A hydrogen-containing water product for beverage comprising:
a packaging container with a straw having a sealing cap attached to an opening;
hydrogen-containing water filled in the container under pressure; and
a gas atmosphere that is generated in a space above the hydrogen-containing water in the container by a heat treatment conducted after the filling under pressure and is present even when at least 90 days elapse after generation, wherein
the hydrogen-containing water has an oxidation-reduction potential of {[−59×(pH value of hydrogen-containing water in hydrogen-containing water product for beverage after elapse of 90 days)]−170} mV or less when being stored at normal temperature for at least 90 days after manufacture.

2. The hydrogen-containing water product for beverage according to claim 1, wherein the gas atmosphere is an atmosphere having a partial pressure of hydrogen gas of 90% or more with respect to the entire atmosphere pressure.

3. The hydrogen-containing water product for beverage according to claim 1, wherein the hydrogen-containing water has a dissolved hydrogen concentration at the time of filling to be equal to or higher than a saturated hydrogen concentration in water at a temperature of the hydrogen-containing water at the time of filling at atmospheric pressure.

4. The hydrogen-containing water product for beverage according to claim 1, wherein a product volume of the container is from 150 mL to 550 mL.

5. The hydrogen-containing water product for beverage according to claim 1, wherein the hydrogen-containing water has an oxidation-reduction potential of {[−59×(pH value of hydrogen-containing water in hydrogen-containing water product for beverage after elapse of 90 days)]−180} mV or less when being stored at normal temperature for at least 90 days after manufacture.

6. The hydrogen-containing water product for beverage according to claim 5, wherein the hydrogen-containing water has an oxidation-reduction potential of {[−59×(pH value of hydrogen-containing water in hydrogen-containing water product for beverage after elapse of 90 days)]−190} mV or less when being stored at normal temperature for at least 90 days after manufacture.

7. A method of manufacturing a hydrogen-containing water product for beverage, the method comprising:
a filling step of filling hydrogen-containing water in a packaging container with a straw having a sealing cap attached to an opening under pressure;
a sealing step of sealing the opening of the packaging container with a straw in which the hydrogen-containing water was filled with the sealing cap; and
a heat treatment step of subjecting the filled and sealed product to a heat treatment, wherein
the hydrogen-containing water product for beverage has a gas atmosphere that is generated in a space above the hydrogen-containing water in the container by a heat treatment conducted after the filling under pressure and is present even when at least 90 days elapse after generation, and
the hydrogen-containing water has an oxidation-reduction potential of {[−59×(pH value of hydrogen-containing water in hydrogen-containing water product for beverage after elapse of 90 days)]−170} mV or less when being stored at normal temperature for at least 90 days after manufacture.

8. The method of manufacturing a hydrogen-containing water product for beverage according to claim 7, wherein the hydrogen-containing water is filled in the packaging container with a straw at a load pressure of from 0.1 MPa to 0.5 MPa in the filling step.

9. The method of manufacturing a hydrogen-containing water product for beverage according to claim 7, wherein the heat treatment is conducted at a temperature of from 85° C. to 90° C. under a heating condition of from 20 minutes to 1 hour in the heat treatment step.

10. The hydrogen-containing water product for beverage according to claim 2, wherein the hydrogen-containing water has a dissolved hydrogen concentration at the time of filling to be equal to or higher than a saturated hydrogen concentration in water at a temperature of the hydrogen-containing water at the time of filling at atmospheric pressure.

11. The hydrogen-containing water product for beverage according to claim 2, wherein a product volume of the container is from 150 mL to 550 mL.

12. The hydrogen-containing water product for beverage according to claim 2, wherein the hydrogen-containing water has an oxidation-reduction potential of {[−59×(pH value of hydrogen-containing water in hydrogen-containing water product for beverage after elapse of 90 days)]−180} mV or less when being stored at normal temperature for at least 90 days after manufacture.

13. The hydrogen-containing water product for beverage according to claim 13, wherein the hydrogen-containing water has an oxidation-reduction potential of {[−59×(pH value of hydrogen-containing water in hydrogen-containing water product for beverage after elapse of 90 days)]−190} mV or less when being stored at normal temperature for at least 90 days after manufacture.

14. The hydrogen-containing water product for beverage according to claim 3, wherein a product volume of the container is from 150 mL to 550 mL.

15. The hydrogen-containing water product for beverage according to claim 3, wherein the hydrogen-containing water has an oxidation-reduction potential of {[−59×(pH value of hydrogen-containing water in hydrogen-containing water product for beverage after elapse of 90 days)]−180} mV or less when being stored at normal temperature for at least 90 days after manufacture.

16. The hydrogen-containing water product for beverage according to claim 15, wherein the hydrogen-containing water has an oxidation-reduction potential of {[−59×(pH value of hydrogen-containing water in hydrogen-containing water product for beverage after elapse of 90 days)]−190} mV or less when being stored at normal temperature for at least 90 days after manufacture.

17. The hydrogen-containing water product for beverage according to claim 4, wherein the hydrogen-containing water has an oxidation-reduction potential of {[−59×(pH value of hydrogen-containing water in hydrogen-containing water product for beverage after elapse of 90 days)]−180} mV or less when being stored at normal temperature for at least 90 days after manufacture.

18. The hydrogen-containing water product for beverage according to claim 17, wherein the hydrogen-containing water has an oxidation-reduction potential of {[−59×(pH value of hydrogen-containing water in hydrogen-containing water product for beverage after elapse of 90 days)]−190} mV or less when being stored at normal temperature for at least 90 days after manufacture.

19. The method of manufacturing a hydrogen-containing water product for beverage according to claim 8, wherein the heat treatment is conducted at a temperature of from 85° C. to 90° C. under a heating condition of from 20 minutes to 1 hour in the heat treatment step.
